(19) United States
(12) Patent Application Publication
(10) Pub. No.: US 2005/0021678 A1
(43) Pub. Date: Jan. 27, 2005

(54) Satellite network control by internet with file upload and distribution

(75) Inventors: Jeffrey A. Simyon, Alpharetta, GA (US); Keith N. Smith, Oriental, NC (US)

Correspondence Address: HUSCH & EPPENBERGER, LLC, 190 CARONDELET PLAZA, SUITE 600, ST. LOUIS, MO, 63105-3441, US

(73) Assignee: Wegener Communications, Inc., Duluth, GA (US)

(21) Appl. No.: 10/641,187

(22) Filed: Aug. 14, 2003

Related U.S. Application Data
(60) Provisional application No. 60/453,540, filed on Mar. 11, 2003.

(51) Int. Cl. G06F 15/16

(52) U.S. Cl. 709/219; 709/246; 709/232

(57) ABSTRACT

A remotely controlled uplink server system has a remote access interface that allows multiple user groups to individually control their respective media files. The user groups also have individual control over their respective remote receivers. The control over the media files includes file uploading, file management and file distribution and the control over the remote receivers includes the identification and grouping of receivers, managing the play list, scheduling and storage space on the receivers and selecting media channels. Through the remote access interface into the uplink server system, each one of the user groups operates and controls its own fully functioning network operations center, sharing the uplink facility with the other user groups. The uplink server also includes a media manager for storing and managing the media files, a network controller for combining control instructions for the remote receivers with the media files in a broadcast signal, and a transmitter for sending the broadcast signal to the remote receivers over the satellite network.

### CROSS-REFERENCE TO RELATED APPLICATIONS

This application claims the benefit of U.S. Provisional Application Ser. No. 60/453,540, filed Mar. 11, 2003.

### STATEMENT REGARDING FEDERALLY SPONSORED RESEARCH OR DEVELOPMENT

Not Applicable.

### BACKGROUND OF THE INVENTION

1. Field of the Invention

This invention relates generally to satellite transmission systems and, more particularly, to a multi-point to multi-point network in which a plurality of user group operators remotely access an uplink server through a computer network and the uplink server transmits over a satellite to remotely located receivers.

2. Related Art

A known satellite point to multi-point network is illustrated in FIG. 1, wherein the point is referred to as the uplink and the multi-points are called downlinks with the equipment at each downlink referred to as a remote, including a remote receiver. In the satellite control network 10, control information is generated at the uplink 12 and transmitted via the satellite 14 to the downlinks 16. Control information is preferably generated at the uplink 12 by a control computer 18, fed to various conditioning and modulation circuits 20 and combined with other media signals in a combiner 22. These media signals may be video and/or audio fed to the combiner 22 through a modulator 24. These combined signals are transmitted by a transmitter 26 to a particular satellite 14 on a particular frequency. The transmitted signal is retransmitted by the satellite 14 back to locations within a particular geographic footprint area. Remote receivers, using the appropriate receive antenna and addressable logic receive the transmitted signals and determine whether they are an intended recipient.

As disclosed in U.S. Pat. No. 4,985,895, which is hereby incorporated by reference in its entirety, a microprocessor in each remote receiver assemblies and interprets information in the transmitted signals according to a predefined protocol. The protocol enables the transmitter to direct commands to identified sets of remote receivers rather than all of the remote receivers and can switch channels and frequency at will to improve flexibility and security. The protocol defines a special way of packeting asychronously encoded bytes of data so that the remote receiving units may detect packet boundaries, detect one or two bit errors in a packet and correct single bit errors.

The remote receivers may also determine if a packet is targeted or addressed to itself and may parse and execute the implied command of the packet. Multiple data fields in each frame contain identification, data and command instructions.

In the point to multi-point network 10, all of the media content (i.e., the audio and video) is locally managed and controlled at the network operation center for the uplink facility. This is a great benefit for an organization that maintains its own network operation center (NOC) and set of remote receivers. However, many organizations cannot afford their own network operation center and must use a third party service provider that manages the media and possibly the remote receivers for multiple organizations and user groups. In such a case, the use of the uplink facility is shared between the multiple user groups, each one with its own respective sets of media and remote receivers. When the user groups want to change their media content, they must send the audio and/or video to the network operation center for an administrator to upload into media storage. This system creates a bottleneck with the administrator at the network operation center and prevents the user groups from directly controlling their media and sometimes even their remote receivers. Additionally, the user groups have less privacy because the administrators learn the particular operations of each one of the organizations that they service and have access to the media from the respective organizations.

Some prior art satellite systems have limited multi-point to multi-point capabilities, allowing the user groups to directly control their respective remote receivers. However, the user groups must still send their media content to the network operations center for the administrator to upload and manage in the uplink server. Therefore, there still remains the need to increase privacy controls for the media by limiting its access to only those persons in the particular organization and the individuals reached by the remote receivers and the need to reduce the time delay in controlling the media by removing the administrative bottleneck at the network operation center.

### SUMMARY OF THE INVENTION

It is in view of the above problems that the present invention was developed. The invention is a remotely controlled uplink server system with a remote access interface that allows multiple user groups to individually control their respective media files, including file uploading, file management and file distribution, as well as providing the user groups with individual control over their respective remote receivers. In this manner, each one of the user groups operates and controls its own fully functioning network operations center and merely shares the uplink with the other user groups. The uplink server also includes a media manager for storing and managing the media files, a network controller for combining control instructions for the remote receivers with the media files in a broadcast signal, and a transmitter for sending the broadcast signal to the remote receivers over the satellite network.

Therefore, in addition to directly controlling their respective remote receivers by remote control of the uplink server, the present invention allows user groups to directly control their media files also by remote control of the uplink server. The user groups operate their own network operations centers, thereby increasing privacy control over the media and reducing the time to upload and manage the media.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a prior art point to multi-point satellite network;

FIG. 2 illustrates a schematic diagram of a multi-point to multi-point satellite network according to the present invention;

FIG. 3 illustrates a block diagram of the web browser interface;

FIG. 4 illustrates a block diagram of the media manager;

FIG. 5 illustrates a flowchart of the remote control process for managing the remote receivers and the media distribution using remote network operations centers; and

FIG. 6 illustrates a flowchart of the process to define the control instructions.

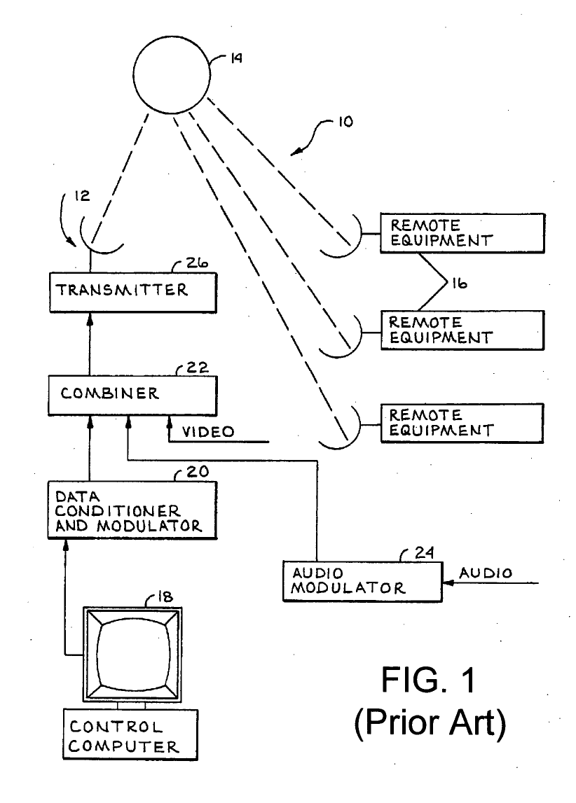

### DETAILED DESCRIPTION OF THE PREFERRED EMBODIMENTS

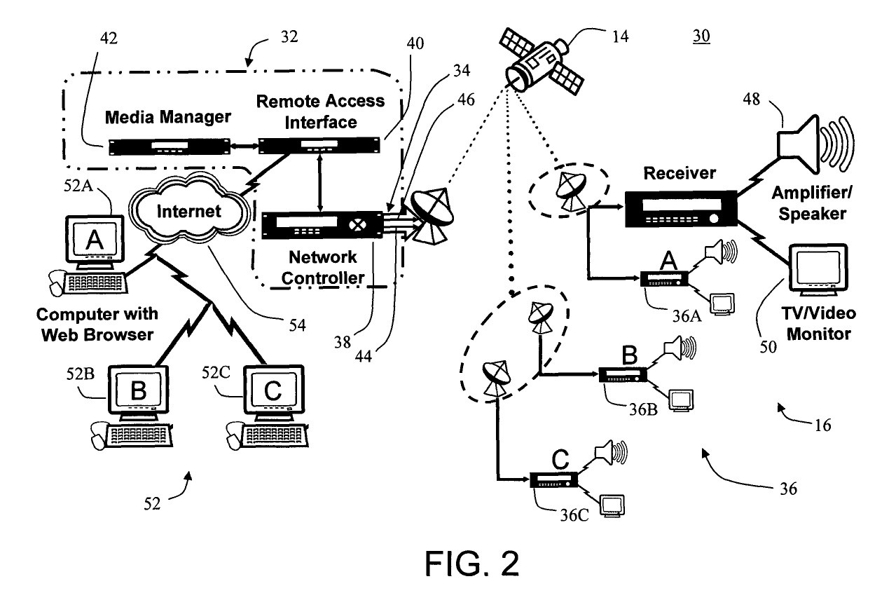

Referring to the accompanying drawings in which like reference numbers indicate like elements, FIG. 2 illustrates a schematic diagram of a satellite network distribution system 30 according to the present invention. The satellite network distribution system has an uplink server 32 that broadcasts signals 34 over a satellite 14 to remote receivers 36 at downlink facilities 16. The uplink server 32 has a network controller 38, a remote access interface 40 and a media manager 42. Preferably, the controller 38, interface 40 and manager 42 are three separate computers that are locally connected at the uplink server location for direct communication with each other. The network controller 38 remotely controls each one of the remote receivers 36 at the downlink facilities 16 by transmitting control instructions 44 to the receivers, preferably in a portion of the broadcast signals 34, with the other portion being used for the program content 46.

As disclosed in U.S. Pat. No. 4,985,895, each receiver 36 with remote control capabilities can be programmed to store the unique receiver address and group address information that is common to several receivers. Therefore, the control instructions 44 can be used to control a selected group of receivers at multiple downlink facilities 16, from all receivers that receive the broadcast 34 to a particular set of receivers, including a single intended receiver. In addition to defining a set of receivers, the control instructions 44 can configure the receivers and command the selected set of receivers with actions to perform, such as activating the receivers to play out the program content 46 over a speaker 48 or a monitor 50.

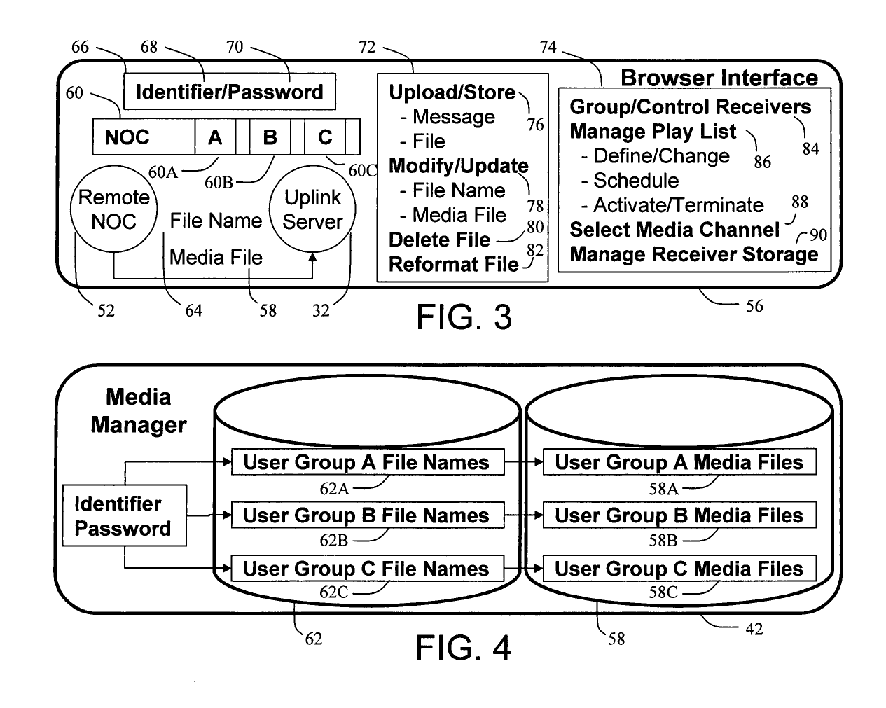

The remote access interface 40 allows a network operator to access and control the uplink server 32 from any remote computer 52 having access to the interface 40 via a computer network 54. With the remote access interface 40, the uplink server 32 provides a web browser interface 56 (FIG. 3) for remote control operations at the uplink side of the network. Accordingly, through the remote access interface 40, any remote computer 52 can access the network controller 38, upload and store media files 58 to the media server 42 and generate control instructions 44 for the distribution of the files 58 over the satellite network 30. The remote access interface 40 can be accessed through any type of computer network 54, including the internet, and permits simultaneous access to the network controller 38 and media manager 42 by multiple computers 52.

The uplink server 32 may host different user groups 60A, 60B, 60C (i.e., organizations, user communities and/or business entities) that each has its own set of receivers 36A, 36B, 36C and its media files 58A, 58B, 58C (FIG. 4), respectively. The media manager 42 is any type of storage device or multiple storage devices that can store files for all of the user groups 60, and the network controller 38 can provide satellite distribution to all of the receivers 36. However, the remote access interface 40 limits the control authority of each user group 60A, 60B, 60C to only its media files 58A, 58B, 58C and its receivers 36A, 36B, 36C, respectively. In this manner, each one of the user groups 60 can use its own respective computer to access of the remote access interface 40 to operate the uplink server facility 32 as its own virtual remote network operations center 52A, 52B, 52C to maintain control over its media 58 and receiver 36 resources apart from the other user groups while all user groups share the same satellite network 14 and control system infrastructure 32. To limit the control authority of each group 60 to only its files and receivers, the uplink server maintains database records 62 of the resources belonging to each user group 60, and the remote access interface 40 limits the network operators 52A, 52B, 52C to their respective groups 60A, 60B, 60C.

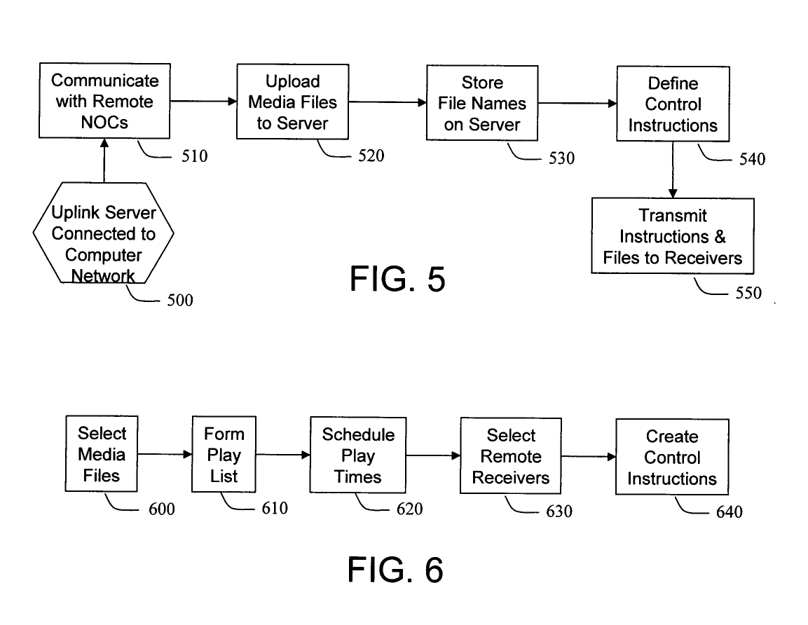

The operation of the uplink server 32 is generally illustrated according to the flowchart in FIG. 5. As discussed above, the uplink server 32 provides the web browser interface 56 over the computer network 54 for the network operator 60 to interactively and remotely access the network controller 38, remote access interface 40 and media manager 42 (500). The uplink server 32 communicates with the remote network operations centers 52A, 52B, 52C over the computer network 54 through the web browser interface 56 (510). As discussed above, each one of the remote network operations centers respectively corresponds at least one of the user groups 60A, 60B, 60C having authorization to use the uplink server 32. The network operator 60 uploads files 58 containing media content 46 to the uplink server 32 through the web browser interface 56 (520). The media content files 58 are preferably stored locally at the uplink server 32 on the media manager 42. The network operator 60 also enters unique names 64 for the media content files 58 and the names are also stored in a corresponding relationship with the media content files (530). The network operator 60 also defines the set of control instructions 44 through the web browser interface 56 (540), and the media content 46 and control instructions 44 are transmitted to the receivers 36 over the satellite network 14 (550).

The network operators 60 launch their web browser application on their respective remote computers 52A, 52B, 52C and connect to the web browser interface 56 provided by the remote access interface 40. To identify the network operator's user group 60 and protect the uplink server system 32 from unauthorized entries, the remote access interface 40 presents an entry screen 66 that preferably requires logging into the uplink server with a valid user identifier 68 and corresponding password 70. With a successful log-in, the uplink server 32 selects the user group database records 62A, 62B, 62C to which the network operator belongs and then only provides the options to manipulate or otherwise control those media and receiver resources 36, 58 that are available for the particular group 60.

The web browser interface 56 can provide similar basic functions for all network operators 60, and the remote access interface 40 controls the information retrieved from the uplink server 32 and provided to the network operators according to their respective user groups 60A, 60B, 60C. For example, the web browser interface 56 can provide a similar operational menu or web page that has options for uploading a media file 72 and/or controlling the distribution of the media files 74. For those media files 58 that are already uploaded into the media manager 42, the uplink server 32 will only display those file names 62 that correspond to the network operator's user group 60 according to the database records 62. Similarly, the uplink server 32 will only display those receivers 36 that correspond with the network operator's user group 60. The web browser interface 56 could also be customized for the different user groups 60 and their particular broadcast methods and operations. Depending on the levels of sophistication for the respective user groups 60A, 60B, 60C, the web browser interface 56 could be simplified for basic functionality and control or could be enhanced for special applications.

To upload a file to the uplink server 32, the network operator 52 connects to the remote access interface 40 through a browser 74 using a standard protocol, such as hyper-text transfer protocol (http), selects a media file 58 and sends the file to the media manager 42 through the web browser interface. The web browser interface 56 is preferably menu driven and can prompt the network operator with data fields for entering information to the uplink facility and can also include graphical representations to assist the network operators. For example, the user could select an upload command from a file management menu 72. The web browser interface would then communicate the upload and/or store mode command 76 to the media manager through the remote access interface. One upload command could be UPLOAD MESSAGE, and the web browser interface would respond by providing a name field and an upload screen for the network operator to describe or otherwise identify the media file to be uploaded. The network operator uses the browser to select the media file at their remote location and selects UPLOAD FILE on the upload screen. In response, the remote access interface uploads the media file into the media manager and a new record is created in the user group's database. It will be appreciated that there are also other options for managing the files, including modifying or updating a media file or its name 78, deleting media files 80, and uploading additional media files 76. Regardless of the sophistication of the user groups 60, the remote access interface 40 preferably communicates with the remote network operators 52A, 52B, 52C by using sessioning functionality, including using a key to identify the information belonging to each of the remote network operations centers 52A, 52B, 52C sessions which can be simultaneous with each other.

In the preferred embodiment, the media manager 42 periodically scans an incoming-file folder for new files 58. Additionally, the media manager may also process the uploaded media file to transform it into a different format 82. For example, the satellite receivers 36 may be configured to receive files in a particular format, such as MP2 format for audio files or MPEG2 format for audio-visual files. The receivers distribute the media files to corresponding media devices that can play the media files, such as players for audio files and/or audio-visual files. However, the files uploaded to the uplink server could be a different format, such as MP3-formatted audio files or proprietary-formatted audio-visual files. The media manager transforms the files into the proper format for the satellite receivers 36. In the preferred embodiment, MP3 audio files uploaded to the uplink server 32 are converted first into WAV-formatted files and then into MP2-formatted files. Differently formatted files can be stored in different directories.

The web browser interface also provides a network control menu 74 for defining a set of control instructions 44 for a set of the user group's files 58 and a corresponding set of the group's receivers 36. It will be appreciated that the set of receivers 36 can vary from an individual receiver to any group of receivers belonging to, and therefore controllable by, the network operator's group. As particularly set forth in U.S. Pat. No. 4,985,895, the receivers can store information about any receiver groups that they belong to, allowing receiver sets to be grouped using boolean operators in the control instructions. Similarly, the set of files 58 can also vary in number as well as their play list order and other play list options, as discussed below.

The process to define the control instructions 44 is illustrated in FIG. 6. The remote network operations center 52 can create a play list by defining the name of a play list and selecting a set of media files in a sequential order (600). In particular, the remote network operator 52 identifies the selected media files according to their respective names and preferably defines a time interval between the play out of the files (610). The network operator also schedules the time period over which the receivers are to distribute the media files (620). As discussed, above, a set of the receivers 36 belonging to the user group 60 are identified and grouped (630).

In the preferred embodiment, the receivers use the time intervals to space the media files between other programs that the receivers are playing out. The played programs can be received in real time from a broadcast or can be played out from the receivers' storage during the defined time period. The time intervals can vary from zero, in which case the receivers can be commanded to play only the media files in the play list, to some time that is a portion of the total time period, in which case the receivers will accordingly intersperse the media files with the other programs being played. The play list can also be scheduled according to different times of the day, days of the week, particular dates, parts of the day, or for weeks at a time. Once a play list has been scheduled, it continues until it is changed or terminated. It will be appreciated that during each scheduled time for a play list, the play list may be repeated a number of times according to the time interval and the time period. A termination time can be designated in advance by the control instructions. As discussed above,

The control instructions 44 include information identifying the set of receivers, the play list and the scheduling information (640). Preferably, the control instructions 44 are sent together with the media files 46 and the selected set of receivers store the control instructions and the media files. However, the play list 44 could be sent to the receivers 36 first, followed by the content 46. The receivers 36 can be configured such that anything scheduled in the receiver can be stored in the receiver. When there is limited storage space in the receivers, only the media files in the scheduled play list would need to be stored at the receivers. The other broadcast programs in which the media files are interspersed could be received and relayed in real time without any storage. It will also be appreciated that the media files could also be sent out in real time to the receivers but do not necessarily need to be sent out in real time. The media files and control instructions 44 could be trickled out to the receivers, slower than real time, or pushed out to the receivers, faster than real time. The uplink server 32 preferably sends out a signal to activate the scheduled play list for the corresponding media files 58 on the corresponding set of receivers 36. However, it is possible for the receivers to activate the play list according to the scheduling information stored on the receivers.

An example of the present invention in a real time live broadcast feed with a spaced interspersion of the media files is the play out of advertisements at set intervals in the broadcast. The advertisements could be scheduled based on the time of day in different time zones. Different groups of receivers in different regions could be programmed with different sets of media files—having some of the same national advertisements along with different regional advertisements. In this manner, the entire set of receivers for a user group could be commanded to play out the same broadcasts with some of the same advertisements being interspersed in all of these receivers while the receivers in different regions intersperse different regional advertisements. Another example of the present invention is for receivers programmed to play only the media files, without any live broadcast feed, as in the on-hold audio for a telephone system. In this example, there would be no interval between the media files.

From the description of the embodiments above and the particular examples provided, it will be appreciated that the network operators at the remote network operations centers 52 can interactively communicate with the uplink server 32 over the computer network 54. As discussed above, the network operator can upload the media content files to the uplink server 32 from any remote location 52 and can also manage the media content files 58 stored on uplink server 32. Additionally, network operators can create control instructions 44 for network control and for controlling distribution over the satellite. Through the web browser interface 56, the network operator can interactively manage and control receiver groups using boolean operations 84, manage play lists 86, select media channels (audio and/or video) for live play broadcasts 88, schedule and trigger channels and play lists to play out, manage receiver storage space 90-including the deletion of old media content files and setting retention times and priorities for the files, as well as directing other various receiver control functions-including audio and/or video on/off, setting audio levels, and tuning to a new transponder.

For controlling distribution, the media server can provide the network operator with the means to optimize the timing and bandwidth of media content transmission for best use of receiver storage and transmission bandwidth. For example, in managing file delivery, the uplink server system 32 checks the media files 58 to be broadcast for validity when it is uploaded and then either immediately sends it or puts in a queue to be sent as soon as possible. The user groups 60 may also want to be able to resend their files using an intelligent resend feature, especially when using a Ku-band satellite network. One option for resending files is to make use of the available bandwidth during low bandwidth usage times. The uplink server 32 would look for low bandwidth usage based on an idle bandwidth timer that can be selected by the user groups 60. Once the uplink server 32 identifies an idle bandwidth period that fits the user's criteria (indicating that the satellite network is in a low bandwidth usage period), the uplink server 32 selects at least a portion of the media files 58 and resends them, and then repeats the process until all of the media files have been resent 58. Sometimes only a portion of the media files 58 can be sent, such as when several hours of material are to be resent or when the resend period is greater than the idle bandwidth period. At other times, the entire set of media files 58 may be resent, such as when a few minutes worth of media files are being resent and the uplink server is directed to resend (or determines it can resend based on file size compared with available bandwidth) several minutes worth of material.

Another option for resending media files 58 can be based on a priority system. For example, all initial file transfers would be assigned a top level priority while all resends would be assigned a lower level priority. The uplink server 32 would not resend the lower priority files until all upper priority files in the queue have already been sent.

Yet another option for sending media files 58 can be based on just-in-time-delivery (JITD). For example, the schedule can be prepared several weeks or months ahead. However, the files are sent immediately to the receivers, which is acceptable in many cases, but the memory in some remote receivers could limit the ability to schedule ahead, especially if there is a large volume of media files or the remote receivers have a low storage capability. In JITD, the uplink server 32 would calculate the time at which the files must be sent to the receivers (based on file size as compared with the available bandwidth) and would send the files at the designated time. In this embodiment, the media manager 42 serves as a main storage unit, and the memory in the remote receivers 36 only stores files for the periods that they are needed.

In this manner, it is possible to remotely operate the uplink server 32 and the receivers 36 in the satellite network. The remote operations include media content upload 76, media content management 78, 80, network control (including control over live broadcasts) and the distribution of the media content throughout the network of receivers 84, 86, 88. The remote operators 52 can be given authority to completely control the media content and receivers belonging to the remote operator's user group, without any intermediary controller at the uplink server. For example, according to the present invention there is no need to send a physical copy of media content files to a central location for uploading onto the uplink server.

This remote control operation increases the speed and independence with which media content files 58 can be uploaded and distributed for a particular user group 60. Once the network operator 52 for the user group 60 has a new media content file 58 at the remote location, the file can be uploaded, distributed and played out at any one or all of the receivers within several minutes or even seconds, such as with the simplified web browser interface discussed above. There is no bottleneck with a central operator 18 at the uplink server or any need to transfer any content in a physical medium. Costs are reduced because multiple user groups 60A, 60B, 60C can use the same infrastructure provided by the uplink server 32, and privacy is maintained because each user group 60 maintains control over its own media 58 and receiver resources 36 apart from the other user groups. Therefore, the interactive remote control of the uplink server, from media content upload and management to network control and distribution over a satellite to a set of receivers allows many user groups 60A, 60B, 60C to operate their own network operations centers 52A, 52B, 52C and manage their own resources 36, 58 in a timely and cost-effective manner and without compromising privacy.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A method for controlling media distribution over a satellite network, comprising the steps of:
connecting an uplink server to a computer network through a web browser interface;
communicating with a plurality of remote network operations centers over said computer network through said web browser interface, wherein said plurality of remote network operations centers respectively correspond with a plurality of user groups;
uploading a plurality of files containing media content to said uplink server received from said remote network operations centers through said web browser interface;
storing on said uplink server a plurality of names uniquely corresponding with said media content files;
defining a set of control instructions for a set of said files and a corresponding set of receivers through said web browser interface; and
transmitting said media content files and said control instructions to said receivers over the satellite network.

2. The method according to claim 1, wherein said defining step comprises the steps of:
selecting a set of said media content files through said web browser interface;
forming a play list for said selected set of said media content files, wherein said play list is comprised of a set of names corresponding with said selected set of media content files;
scheduling a set of play times for said play list through said browser interface;
selecting said set of receivers through said web browser interface; and
creating said set of control instructions according to said play list, said play times and said set of receivers.

3. The method according to claim 1, wherein said uploading step further comprises the step of converting said media content in said files from a first format to a second format.

4. The method according to claim 1, wherein said communicating step further comprises the step of controlling access to said media content files and said set of receivers according to said plurality of user groups.

5. The method according to claim 4, wherein said step of controlling access further comprises the steps of:
associating a respective set of receivers with each of said user groups;
tracking a respective set of media content files according to each of said user groups; and
restricting control of said respective set of receivers and said respective set of media content files corresponding with each of said user groups.

6. The method according to claim 5, wherein said step for providing access to said uplink server further comprises the steps of:
assigning at least one unique user identifier and password pair to each of said plurality of user groups; and
providing an entry screen where said plurality of user groups can log into said uplink server.

7. The method according to claim 1, wherein said communicating step further comprises providing a browser interface menu to said plurality of user groups through said computer network.

8. The method according to claim 1, wherein said communicating step further comprises providing at least one customized browser interface menu to at least one of said user groups.

9. The method according to claim 1, further comprising the step of identifying and controlling said set of receivers with said control instructions.

10. The method according to claim 1, further comprising the step of resending the media files according to an intelligent sending function, wherein said intelligent sending function is selected from the group of functions consisting of a low-bandwidth system, a priority-based system, and a just-in-time-delivery system.

11. A remotely controlled uplink server system for a satellite network, comprising:
a storage device containing a plurality of media content files;
a database containing file names respectively corresponding with said media content files; and
a web browser interface in communication with said storage device and said database, said web browser interface having a file management menu for uploading said media content files into said storage device and entering said file names into said database and having a network control menu for selecting a set of said media content files and creating a corresponding set of control instructions for said selected set of media content files.

12. The remotely controlled uplink server system according to claim 11, further comprising a file converter for converting the media content from a first format to a second format.

13. The remotely controlled uplink server system according to claim 11, further comprising a plurality of access controls, said access controls respectively corresponding with a plurality of user groups, wherein each of said user groups is associated with a set of media content files in said storage device and a corresponding set of remote receivers at a plurality of downlink facilities.

14. The remotely controlled uplink server system according to claim 13, wherein said plurality of access controls is comprised of at least one unique user identifier and password pair for each of said plurality of user groups.

15. The remotely controlled uplink server system according to claim 14, further comprising a network controller for combining said control instructions with said media content files in a broadcast signal and a transmitter for transmitting said broadcast signal to at least one set of remote receivers in the satellite network, wherein said control instructions identify and control said set of remote receivers.

16. The remotely controlled uplink server system according to claim 15, further comprising a plurality of remote network operations centers operatively connected to the uplink server through said web browser interface over a computer network.

17. The remotely controlled uplink server system according to claim 16, further comprising an intelligent sending function, wherein said intelligent sending function is selected from the group of functions consisting of a low-bandwidth system, a priority-based system, and a just-in-time-delivery system.

18. A remotely controlled uplink server system for a satellite network, the uplink server being remotely controlled over a computer network and the satellite network transmitting to a plurality of remote receivers, comprising:
a media manager containing a plurality of media content files and having a database containing file names respectively corresponding with said media content files;
a remote access interface in communication with the computer network and said media manager, said remote access interface having a web browser interface with a file management menu and a network control menu and having a plurality of access controls, said access controls respectively corresponding with a plurality of user groups, wherein each of said user groups is associated with a set of said media content files in said media manager and a corresponding set of the remote receivers;
a plurality of remote network operations centers operatively connected to the uplink server through said web browser interface over the computer network;
a network controller for combining said control instructions with said media content files in a broadcast signal; and
a transmitter for transmitting said broadcast signal to at least one set of the remote receivers.

19. The remotely controlled uplink server system according to claim 18, wherein said file management menu comprises a plurality of media management options selected from the group consisting of uploading said media content files into said media manager, entering said file names into said database, modifying said media content files, and deleting said media content files.

20. The remotely controlled uplink server according to claim 19, wherein said network control menu comprises a plurality of distribution options selected from the group of selecting a set of said media content files, selecting a set of said remote receivers, and creating a corresponding set of control instructions.

21. The remotely controlled uplink server according to claim 20, wherein said plurality of access controls is comprised of at least one unique user identifier and password pair for each of said plurality of user groups and a user group restriction according to said identifier and password pair; said user group restriction limiting each one of said user groups to view, manage, and control only its associated set of media content files and corresponding set of remote receivers.

22. The remotely controlled uplink server according to claim 18, wherein said media manager further comprises a file converter with a conversion of said media content files from a first format to a second format and wherein said network controller further comprises an intelligent sending function, wherein said intelligent sending function is selected from the group of functions consisting of a low-bandwidth system, a priority-based system, and a just-in-time-delivery system.
